(19) United States
(12) Patent Application Publication
(10) Pub. No.: US 2008/0185949 A1
(43) Pub. Date: Aug. 7, 2008

(54) Plasma flare IR and UV emitting devices

(76) Inventors: Jan Henrik Jebsen, Dully (CH); Gerard Aknine, Coppet (CH)

Correspondence Address: WILEY REIN LLP, 1776 K. STREET N.W., WASHINGTON, DC, 20006, US

(21) Appl. No.: 11/375,579

(22) Filed: Mar. 15, 2006

Related U.S. Application Data
(63) Continuation-in-part of application No. PCT/CH04/00578, filed on Sep. 14, 2004.

(51) Int. Cl. H01J 17/26

(52) U.S. Cl. 313/231.41; 250/504 R

(57) ABSTRACT

The invention relates to a plasma torch generator employed in a device or system that can be used to protect aircraft or vehicles from IR and UV seeking or tracking mechanisms. In one embodiment, the invention comprises a deployable broad spectrum, IR and UV emitting device containing the plasma torch, which can function as a countermeasure flare. The plasma torch can be used with a powered flare or housing that can be launched

### REFERENCE TO RELATED APPLICATIONS

This application is a continuation-in-part of PCT/CH2004/000578, filed Sep. 14, 2004, which claims priority benefit of U.S. Provisional Application 60/502,657, filed Sep. 15, 2003, and the entire contents of each of these documents is hereby incorporated by reference.

### FIELD OF INVENTION

This invention relates to deployable plasma-generating devices and mechanisms that can be used to emit IR and UV radiation. The devices and mechanisms can be incorporated into countermeasure systems and methods to protect aircraft from passive tracking and/or detection systems. In a particular embodiment, the device or mechanism can be incorporated into powered flares that can be launched from vehicles or aircraft.

### BACKGROUND FOR AND INTRODUCTION TO THE INVENTION

A variety of missile systems have been used against vehicles and aircraft. Man-portable air defense systems, anti-aircraft missiles, and even anti-tank TOW missiles have been proven effective against aircraft and helicopters. Countermeasure systems to neutralize this threat typically employ heat-emitting decoys and/or chemical flares. Systems that use flares, however, suffer form a number of disadvantages. For example, many recently developed missiles use target-seeking mechanisms that are not deflected by flares.

Another system currently used to protect aircraft is directional infrared countermeasures. These systems use a powerful lamp to send a beam to jam the infrared seeking mechanisms on the missile (see, for example, AN/ALQ-204 by Lockheed Martin, N.Y.). Again, these systems have not proved to be successful against the newer missiles and target seeking mechanisms. Similarly, laser-based directional countermeasure systems (AN/AAQ-24 (V)/Viper (NEMESIS) by Northrop Grumman Defensive Systems Division, Rolling Meadows, IL; AN/ALQ-212 (ATIRCM) by BAE Systems, Nashua, N.H.; EOSDS (Electro-Optical Self-Defense Suite) by Rafael, Israel) employ a laser beam to jam or disable the target-seeking mechanism of a missile. However, the ability to focus and directionally control laser beams in order for these systems to be reliably effective is lacking.

Furthermore, existing systems typically do not employ countermeasures for target-seeking mechanisms that seek UV radiation or combinations of wavelengths that include Uv radiation, and no reported or available systems account for this deficiency. Accordingly, new and more effective countermeasure systems are needed in the art.

As described in more detail below, the invention provides the novel use of plasma and a plasma generator in countermeasure devices. Plasma is a high temperature, luminous gas, which is at least partially (1 to 100%) ionized. Thermal plasma can be created by passing a gas through an electric arc. The electric arc will rapidly heat the gas by resistive and radiative heating to very high temperatures, within microseconds of passing through the arc. Plasma is typically luminous at temperatures above 9000° K. The plasma used as described here can be an effective replacement to the chemical flare or other existing flare and can emit a UV and IR signature that will increase the effectiveness and operational functionability of countermeasure systems.

### SUMMARY OF THE INVENTION

In one aspect, the present invention provides improved countermeasure devices that can be incorporated into conventional or available countermeasure systems to protect against the threat of passive detection, target-seeking missiles. This can be achieved by combining the technology for identifying a threat and for launching a countermeasure with the new countermeasure flare of the invention, which emits high intensity heat and light over a broad range of the electromagnetic spectrum, including IR and UV. The new countermeasure flare technology incorporates a plasma generator or plasma reactor, described in detail below. As known and used with plasma torches, the new countermeasure flare can incorporate the use of one or more gases, or a mixture of gases, to generate extremely high temperatures. The plasma reactor generates heat and light that simulates a target for an IR (or any light) seeking missile and may create a much more intense target, one that the IR seeking missiles will find and track instead of a vehicle or aircraft.

Furthermore, because the countermeasure device of the invention can be operated so that the plasma reactor initiates after launch from a vehicle or aircraft, and can be propelled a distance from the vehicle or aircraft, the flare does not present a danger to the vehicle or aircraft it is designed to protect. Combining the plasma reactor flare with an available or conventional small rocket will accomplish the propulsion away from the vehicle or aircraft.

In general, the devices and methods of the invention can function to create an intense heat and radiation/light source through a plasma reactor, which is used to redirect an IR/UV seeking missile away from its intended target. Because the source of radiation or light covers a broad range of the electromagnetic spectrum, it is useful against many different heat or light seeking devices and is more useful than currently used flares.

Many existing plasma torch devices are used in cutting, welding, marking, or any other thermal treatment of a metallic or non-metallic material. The plasma torch generally comprises a copper or copper alloy electrode with a cylindrical insert of hafnium, tungsten, or zirconium, on which the electric arc can initiate, which arc serves to ionize the gas. The flow of gas, usually pressurized gas or so-called plasmagenic gas, is preferably supplied at a point near the electrode, for example, through an orifice of a nozzle located adjacent to the electrode.

Any of the conventional or existing plasma torch devices can be adapted for use with this invention. The operation of conventional torches is well understood by those skilled in the art and a detailed explanation thereof is not necessary for purposes of this disclosure. However, many of the concerns leading to the design of existing plasma torches, nozzle damage, electrode erosion, and maintaining a stable arc, are not applicable here because of the relatively short time period the plasma reactor is designed to operate, on the order of 5-10 seconds or perhaps up to 1-5 minutes. Therefore, a range of options can be used in adapting a plasma torch device for this invention.

The operation of conventional plasma torches is well understood by those in the art. The basic components of these torches are a body, an electrode mounted in the body, a nozzle defining an orifice for ionizable gas, a source of ionizable gas, and an electrical supply for producing an arc. The ionizable or plasmagenic gas can be non-reactive, such as nitrogen, or reactive, such as oxygen or air, or many other gases or mixtures. One of skill in the art will understand that the arrangement of the electrode to essentially form an anode and cathode between which an arc can form, the voltage across the cathode/anode gap, the current across the anode/cathode gap, the pressure of the air or gas, the duration of the voltage and current pulse(s), and the material used for anode/cathode and/or electrode surfaces. One of skill in the art can vary the length, size, temperature, and duration of the plasma torch. By appropriate adjustment of these parameters, the plasma reactor device can be used to emit a wide range of heat and light or radiation combinations.

In one of the particularly advantageous features, the invention comprising the use of a plasma reactor is simpler, cheaper, and more durable than laser-based systems and lacks the requirement for precise, directional control in order to be effective.

In a particular embodiment, the countermeasure flare is designed to produce an intense UV and IR signature. The high intensity plasma reaction (about 10,000 to about 15,000° K and about 4 to about 10 kW power output) mimics the engine plume of a jet aircraft. The range of electromagnetic light waves produced is from as low as about 120 nm or about 200 nm up to about 40 um or 300 um. Using plasmagenic gases such as O₂, CH₄, or H₂, optionally in combination with N₂, a very high energy density is produced. For example, a mixture of approximately 35% H₂ and 65% N₂ can generate an energy density over the effective area of the gas nozzle of about 12,000 to about 20,000 Amps per square inch. The plasma torch created can be from about 20 to about 50 cm in length and can persist for preferably about 3 to about 10 seconds, but can also be designed to persist for up to three minutes with larger gas supply tanks. Of course, one of skill in the art can design plasmagenic gas combinations that mimic one or more aircraft engine and exhaust signatures, and multiple plasma reactor devices can be outfitted on an aircraft or even in one deployable housing so that the countermeasure used or selected is most effective against a range of potential threats. Thus, a preferred intense LV and IR signature generated by the plasma flare device of the invention can be the particular combinations of wavelengths present or emitted from a light source such as a vehicle engine, aircraft, or jet engine.

In one method of operation or in one of the optional configurations, the countermeasure flare is incorporated into a standard 75 mm metal rocket body. The rocket body is equipped with one or more of a firing rocket to launch it from an aircraft, a parachute, a plasma reactor to create a plasma torch, a high voltage high current generator, pressurized gas supply tank(s), and conventional electromechanical control systems for initiating the electric arc to start the plasma reaction and maintain the flow of gas. More particular aspects include a protection window or shield to optimize the plasma torch in a turbulent airflow environment, such as protruding tube that covers all or a portion of the plasma torch and permits UV and IR radiation to pass through. Optionally, the protruding tube or window may contain a pressure regulator to control the pressure within the tube. In certain designs, the tube can be closed, or closed with regulators or openings, or open at one or more points along its length. Functionally, the tube or window permits the plasma torch to persist through its designed duration and permits the appropriate UV and/or IR signature to reach any target-seeking missile.

In yet another aspect, the invention comprises a method for redirecting a fired target-seeking missile, employing a plasma reactor. For example, the invention encompasses a method whereby a plasma countermeasure flare is deployed from a vehicle or aircraft, where the countermeasure flare comprises a plasma torch generator comprising a cathode, an anode, a gas passage for allowing pressurized gas to flow between the anode and cathode, a gas tank, and a power source electrically coupled to the anode and the cathode. In one preferred embodiment, a first voltage is applied between the anode and cathode to cause an arc (pilot arc) to form. Pressurized gas is applied to the arc or to the gap between the anode and cathode via a gas passage, usually a nozzle directing gas in a specified direction and pattern. As used here, “gas” can be one or more plasmagenic gases or other gas(es) that do not interfere with the generation of a plasma torch, or it can be or can include air. A current is then applied to generate a plasma torch and produce a plasma reaction. The plasma torch generally is long enough to pass outside of a body or housing for the plasma torch generator. The order of the steps listed above, or elsewhere in the methods of this invention, need not necessarily be exactly the same as written.

Similarly, the invention encompasses a method for calibrating a plasma torch generator to create a plasma reaction that can be detected by a passive tracking system used in a missile. The method can comprise altering one or more of a number of factors involved in or known to be involved in generating a plasma torch. For example, the type and material of cathode or anode used, the gap between the cathode and the anode, the voltage used, the pressure of the gas or air, the type of gas or mixtures of gases used, the duration of the plasma torch, the UV and IR signature of the plasma torch, and the size of the plasma torch can all be varied to optimize, either one factor at a time or more than one factor, to generate a desired plasma torch. One of skill in the art is familiar with method and techniques to vary each of these factors. Preferably, the gas or gas mixture is selected to mimic the radiation signature of the aircraft it is designed to protect so that the target-seeking mechanisms will be directed toward the countermeasure flare rather than the aircraft.

As described here, a preferred embodiment of the methods or devices of the invention employs one or more plasma torch generators capable of using a 5 to 10 sec pulse of current, for example, to generate a plasma torch for at least 5-10 sec. A shorter or longer pulse can be used, including less than 1 sec, up to about 3-5 minutes, and any range in between these values. Additional preferred aspects include, for example, embodiments in which one or more of the plasma torch generators or operating with one or more generators: a vortex cathode; a continuous air flow over the cathode/anode of about 3 to about 5 bar; a pressurized air supply at about 3 to about 5 bar or from about 3 to about 10 bar; an initial arc generating voltage of between about 3 kV and about 20 kV; a torch generating a current pulse, or high current pulse, of approximately 15 amps, whereby a 100 V/15 amp or 85 V/15 amp pulse crosses the anode/cathode gap; a power source for generating an initial arc and a separate power source for generating a current pulse; a nickel plated copper cathode; a copper anode; a torch guide; a tungsten torch guide; and ceramic insulators.

The plasma torch generator, plasma reactor device, and methods of the invention can be manifested as in one of the Figures accompanying this disclosure. Also, numerous embodiments and alternatives are disclosed in the accompanying claims. Other embodiments and advantages of the invention are set forth in part in the description that follows, and in part, will be obvious from this description, or may be learned from the practice of the invention.

All of the references, documents, and information sources listed in this disclosure can be used by one of skill in the art to make and use the invention. In addition, each reference, document, or information source listed is hereby incorporated in its entirety into this application.

### BRIEF DESCRIPTION OF THE DRAWINGS

For a more complete understanding of the invention and some advantages thereof, reference is now made to the following descriptions taken in connection with the accompanying drawings in which:

FIG. 1 shows a schematic of an exemplary rocket body housing a plasma torch generator. The rocket is equipped with a parachute (shown deployed (50) and stored (51) in a compartment), a battery pack (53), a rocket engine (52), a high voltage power source or generator (54) to create the pilot arc and plasma arc in the plasma reactor/generator, a control system (54) for initiating power and flow of gas, one or more gas tanks (56) using, for example, N₂ or H₂ gas, and a plasma reactor or plasma generator (57). Optionally, the housing incorporates a shielding tube comprising UV/IR windows (58) to protect the plasma from turbulent airflow.

FIG. 2 shows a close-up view of a rocket as in FIG. 1. Each gas tank (63), here three tanks containing for example Hydrogen, Nitrogen, air, is connected to the plasma head (59) or plasma generator through tubes (60) and a valve (61) (here an electrically controlled valve). The various gases can be combined or mixed through a mixing chamber (62) or flow ring (gas mixer). The electrode sends power from the power source (65) though distibution tubes (64) to the cathode/anode in the plasma head to generate a plasma torch.

FIG. 3 shows a schematic of a plasma countermeasure flare in operation, where the rocket has been deployed from an aircraft, the optional parachutes have deployed in the rockets, and the plasma flares are generating intense heat and light to deflect target-seeking missiles.

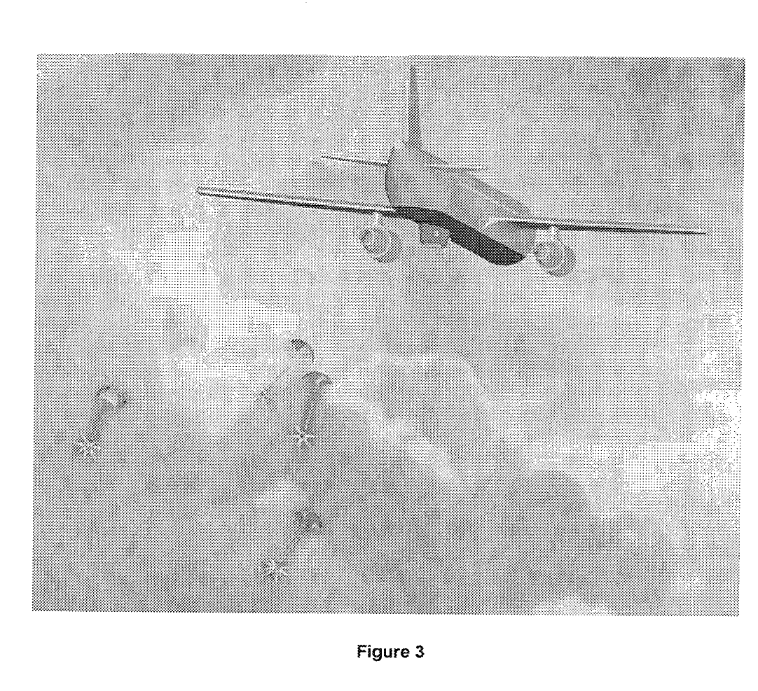

FIG. 4 shows a schematic diagram of one embodiment of a plasma generator.

FIG. 5 shows an exploded view of a multi-probe embodiment of the invention, and exemplary component parts.

FIG. 6 shows the embodiment of FIG. 5 in assembled form.

FIG. 7 shows an exploded view of an exemplary plasma generator or plasma head device for use in the invention.

FIG. 8 shows an exploded view of the components of an exemplary plasma torch generator, where the torch (not shown) would be generated at one end of the assembly. This assembly can be incorporated into a housing, such as a rocket body.

FIG. 9 schematically depicts an embodiment of the vortex cathode combined with an exemplary airflow channel.

### DETAILED DESCRIPTION OF THE INVENTION

The plasma generator can be made from existing plasma technology and adapted for use in this invention. Existing examples of equipment allowing a high temperature arc plasma to be generated are used, for example, in thermal spraying, chemical deposition (surface treatment), gas heating, or chemical synthesis. The energy supplied to the gas(es) by the electric arc allows the plasma to generate temperatures above 10,000° K. The choice of plasmagenic gas or gas mixtures is almost unlimited. It is a function of the demands of the process and the desired plasma characteristics. The power range is very extensive, running from a few kilowatts to several megawatts. Very often, the potential operational range is dictated by the type and flow of the plasmagenic gases selected. For purposes of the invention, the choice of gases may be selected to mimic the radiation signature of a given aircraft.

A first example of a known torch operates with an air/argon or oxygen/argon mix, with power about 100 kW. A second example of a known torch was developed for the hydropyrolysis of heavy hydrocarbons and uses argon and hydrogen mixed with methane at the torch output. This torch is similar to a thermal spray gun. A third example may is one of the simplest torches, marketed as thermal spray guns (see, for example, Sulzer Metco, Westbury, NY; HyperTherm, Hanover, N.H.). This type of torch operates conventionally with argon, helium and nitrogen singly or in mixtures. Hydrogen is often added to gain power (increase in peak arc voltage). Such torches or installations are well known to those skilled in the art because they have already been described in numerous documents that can be referred to for greater detail, particularly U.S. Pat. documents 4,521,666, 5,591,357, 6,329,328; J. R. Roth, “Industrial Plasma Engineering”—Vol. 1, Briston: Principles Institute of Physics (1995); T. B. Reed, “Induction-coupled Plasma Torch”, J. Appl. Phys., Vol. 32, No. 5, pp. 821-824 (1961); M. I. Boulos, “Thermal Plasma Processing,” Pure Appl. Chem., Vol. 57, No. 9, pp. 1321-1357 (1985), each specifically incorporated herein by reference.

As shown and explained below, a single or multiple plasma torch generators can be used, where the multiple plasma torch generators are typically synchronized to fire together, but may be fired sequentially.

A power supply or power source is provided to supply electrical current to the electrode. A negative power lead is in electrical communication with supply tube and cathode. In forming an electrical pilot arc, a positive power lead can be in electrical communication with an anode through a switch. An insulating body electrically isolates the anode from the cathode. The anode and cathode may also be isolated from each other by spacing one apart from the other. The power source may constitute any conventional DC power generator sufficient to provide the current to the torch at an appropriate voltage to initiate the pilot arc and then to maintain the arc in the operational plasma reactor mode of the torch. The power source can be a conventional power generator for a hand held plasma torch, for example, and can be coupled to a battery.

During the pilot arc mode or step, a switch can be closed so that the positive lead is connected to the anode. The power source provides current at the appropriate voltage to initiate the pilot arc between electrode element and nozzle (which can operate as anode). The desired plasmagenic gas flow and pressure are set so that gas flows through the nozzle. The pilot arc can optionally be started by a spark or other means, such as a contact starting technique, all of which are known in the art. The plasma gas flow during the pilot arc mode is from the one or more gas tanks, through a supply line, control valves, an optional mixing chamber, mixing device, or mixing regulator, such as valves with swirl ring, into lower plasma chamber or supply line, and out through the arc passageway of the nozzle.

The pilot arc formed between the cathode and anode ionizes gas passing through the nozzle orifice (gas passage). In one optional configuration, a distant anode can be set up. As the ionized gas reduces the electrical resistance between the electrode and the distant anode, the arc transfers from the nozzle to the distant anode. The torch can then be extended. Additionally, metallic chaff, as used conventionally to produce false radar return signals, can optionally be added to the gas flow to create additional countermeasure effectiveness, or can be deployed from the aircraft along with the deployable flare of this invention.

A plasma flare can be produced with any number or combination of gases in this manner. Optional uses for reactive plasma devices can be incorporated here, so that plasma characteristics can be modified if desired. Previous plasmagenic gas might be neutral (argon, helium, neon), reductive (hydrogen, methane, ammonia, carbon monoxide) or oxidative (oxygen, nitrogen, carbon dioxide), as well as oxygen or oxygen/argon gas mixtures. Others include nitrogen, ammonia, hydrogen, methane, or carbon monoxide. Any mixture of two or more of these gases may also be selected for use.

The details of plasma generating torches are well known and need not be further detailed within this disclosure to make the present invention understandable to those skilled in this field.

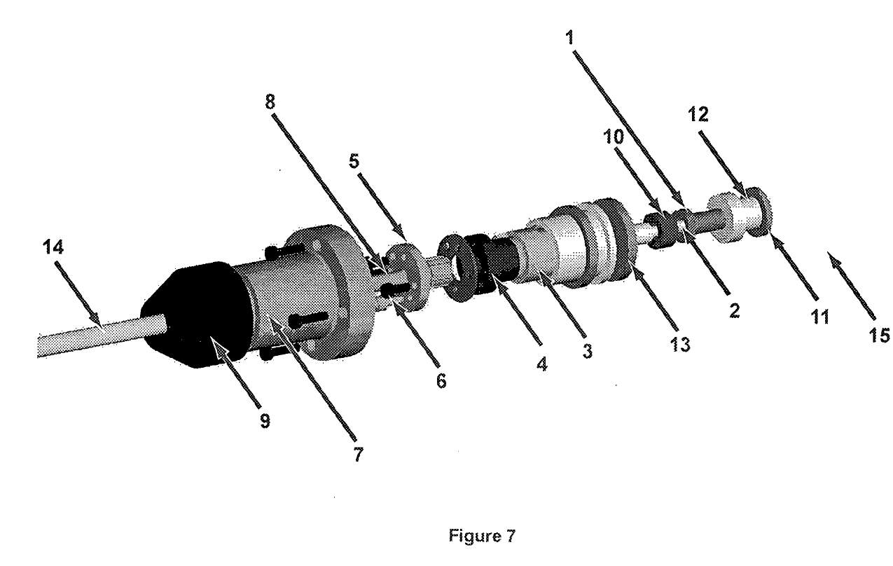

In one preferred embodiment, the present invention may be used as a plasma torch in conjunction with conventional rocket. FIG. 7 shows an exploded perspective of one embodiment of part of the plasma generator head section of the present plasma generator. Anode (1) surrounds vortex cathode (2). One or more of the anode and vortex cathodes are electrically connected to a power supply (not shown). The anode contact (3) makes electrical contact with the anode and the power supply to cause an arc (electric arc or pilot arc) to form across the anode/cathode gap. The cathode insulator (4) prevents a short circuit between the anode and the vortex cathode. Connector (5) provides holes to permit airflow from the gas supply via gas passage (8) to the anode cathode gap. Cathode connector (6) provides a path for electrically connecting the vortex cathode to the power supply. Cover (7) attaches to structural element (9), which can be attached to a rocket body, to enclose the anode/cathode assembly and to prevent the escape of high-pressure gas from the gas supply. Gas passage (8) provides a conduit for high-pressure gas to flow from the gas supply or tanks (14) to the anode/cathode gap. Gas escape passages can also be employed (not shown) to allow the gas from high-pressure gas flow to more easily exit the device and/or vent to atmosphere. The plasma torch is formed at area 15.

Preferably, the gas used is a mixture of oxygen and hydrogen, or a mixture of oxygen, hydrogen, and air. Other gases, for example Argon or Nitrogen, can be used. Once the unit is deployed from a vehicle or launched from an aircraft, gas flow can be continuous to protect the components from discharge gases reentering the mechanism and fouling the cathode/anode airflow. Gas flow can also be used to, or can function to, cool the anode and cathode or insulators, although cooling may not be necessary. A brace (9) encloses a cable to provide a connection to the power supply (not shown) as well as a cover to seal gas within the mechanism. Air flow distributor (10) serves to direct air flow from connector (5) to vortex cathode (2), which is shaped to cause the air to swirl in a vortex around the vortex cathode and out through the anode/cathode gap toward the primer of a chambered cartridge. Gasket (11) and gasket (13) provide additional seals to prevent the escape of air pressure from the mechanism. Insulator (12) isolates the anode.

In one embodiment, the plasma torch can be generated by first causing an arc to form across a gap between a cathode (preferably a vortex cathode) and an anode. In one example, 3 kV to 20 kV across the anode/cathode gap generates an arc, but many other voltages or methods can be selected. The voltage can be applied across the anode/cathode gap for a specific period of time. A current pulse or high current pulse from a power source to the cathode/anode gap and pressurized gas or air flowing between the cathode and anode generates a plasma torch, or extends the plasma arc into a plasma torch. The plasma torch is capable of being detected by IR and/or UV seeking systems. Gas and/or air flow preferably is continuous to protect the components from discharge gases reentering the mechanism and fouling the cathode/anode air flow. Gas or air flow can also function to cool the anode and cathode or other components. In alternative embodiments, the air flow can be applied intermittently as pulses of high pressure air that are synchronized with the high current pulse, which slows the depletion of the gas supply and reduces the amount of high pressure gas that must be stored.

In a preferred embodiment, more than one pulse across the cathode/anode gap is used to significantly increase the energy of the plasma torch and direct its position. The power supply may use a first generator to supply the voltage to create an initial arc and a second generator to supply the current to generate the plasma torch. Alternately, a single generator capable of varying its voltage and current may be used. Thus, one of skill in the art can substitute a variety of electrical elements to construct a suitable power supply for generating a plasma torch in accordance with the present invention. In the two generator embodiment, a first generator is energized to apply a voltage across the anode/cathode gap, generating an arc. The voltage is preferably between about 3 kV and about 20 kV. A current of about 15 amps, which also produces about 85 volts, generates a plasma arc. A range of currents can be used beyond the approximately 15 amps of current exemplified here, as one of skill in the art understands. When a firing sequence is initiated, a gas supply applies high pressure gas through the gas passage to extend the plasma arc into a plasma torch that extends towards a mechanical primer or to a cartridge or propellant charge. The pressure of the high pressure gas is preferably between about 3 to about 5 bars. The second generator is a high voltage generator that is synchronized with the flow of gas from the gas supply. Shortly after the high-pressure gas is introduced, the second generator is energized to apply approximately 15 amps from cathode to anode for a short duration (from about 10 msec, to a range of anywhere between 5-10 sec to about 5-300 secs or any range in between these values). This results in a high temperature plasma torch that extends from the gap between cathode and anode. The plasma torch can be directed by optional torch guides that operate to split the plasma torch into more than one torch or to direct the torch to a particular direction.

As will be recognized by one of skill in the art, the pressure of the gas and the duration of the voltage and/or current pulses can be adjusted to vary the characteristics of the plasma torch, including its diameter, its length, and its temperature, as well as its duration. By advantageous selection of these parameters, the present invention can be utilized as a plasma device for a wide variety of countermeasure systems.

The present invention is not limited to any particular arrangement of the displayed components. For example, one of skill in the art will recognize that the gas supply and power supply can be mounted or moved along the body, or can be located external to any moving parts of the rocket, for example integral to or attached to the frame of the weapon, without deviating from the present invention. The gas supply can be arranged to permit gas flow when the bolt head is in the breech closed position and the power supply can be arranged to make electrical contact when the bolt head is in the breech closed position, without requiring either supply to move with the bolt head throughout its range of motion.

Once the high pressure gas is initiated, it preferably is applied continuously, permitting the firing of successive cartridges to be controlled by the successive application of current pulses. Once initiated, air flow can be stopped either manually by the operator, or automatically after a preset duration has passed without firing.

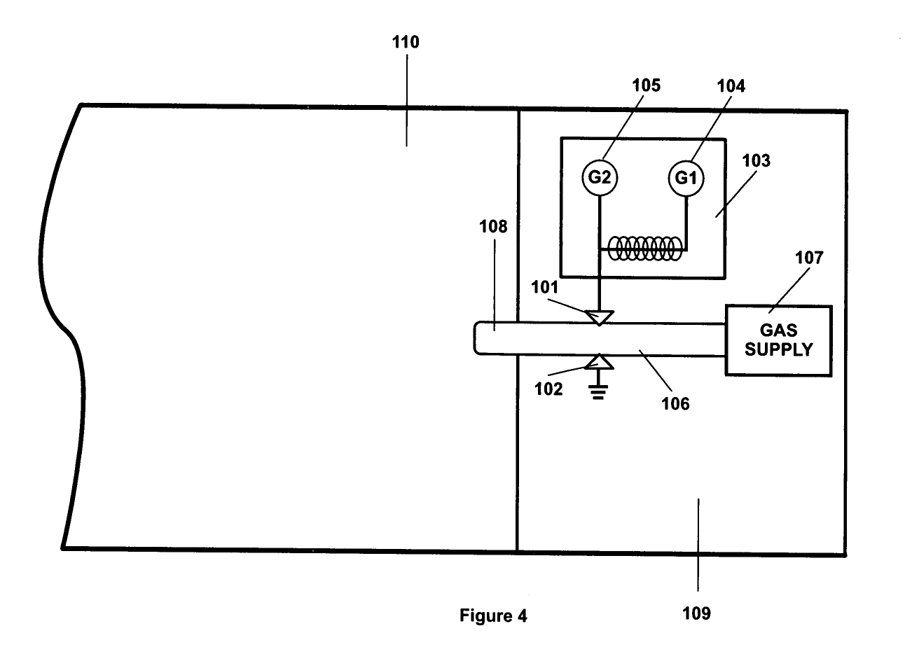

The components of the plasma generator or plasma reactor device are depicted in FIG. 4, including the cathode (101), the anode (102), the power supply (103) comprising the first generator G1 (104) and the second generator G2 (105), the gas passage (106), and the gas supply (107). As noted, G1 and G2 can be one or more power sources capable of generating more than one current and/or voltage pulse. The gas passage (106) typically is formed as a directional nozzle to control the flow and pattern of gas. When initiated, a gas passage (106) provides a path for the plasma torch from cathode (101) and anode (102) into a shielded area or tube for extending the plasma torch (110). In this and other embodiments of the invention, the gas can be used as a continuous or intermittent gas supply to generate a plasma torch as well as to cool the component parts and/or to direct the plasma torch out the orifice in the desired direction, i.e. toward the primer surface or other ammunition or propellant charge.

A first generator G1 is energized to generate a first voltage, preferably about 20 kV, from cathode (101) to anode (102). When the flare firing sequence is initiated, by any suitable mechanical or electrical method, the gas supply and/or gas tank control valve (107) initiates the flow of high pressure gas through the gas passage (106) to extend the plasma arc into a plasma torch (108) that extends towards tube (110). In some embodiments, the pressure of the high pressure gas is preferably between about 3 to about 5 bars. The second generator G2 can be a high current generator that is synchronized with the introduction of high pressure gas from the gas supply. Shortly after the gas is introduced, second generator G2 is energized to apply approximately 15 amps from cathode to anode for a short duration, with a minimum of preferably about 5 msec. This results in a high temperature plasma torch (108) that extends to the tube (110). The pressure of the gas and the duration of the current can be adjusted to vary the characteristics of the plasma torch, including its diameter, its length, and its temperature as well as its duration to advantageously adjust the plasma firing device for use with various projectile sizes and propellant loads. Air flow can also be used to cool the anode and cathode, although it is likely not to be necessary for the relatively short duration of plasma intended in some of the embodiments here. Alternatively, successive current pulses can be used. Once initiated, continuous air flow can be stopped either electronically or through expiration of the gas tanks. Alternately, the air flow can be applied intermittently as pulses of high pressure gas or air that is synchronized with the high current pulses, which slows the depletion of the gas supply and reduces the amount of high pressure gas that must be stored.

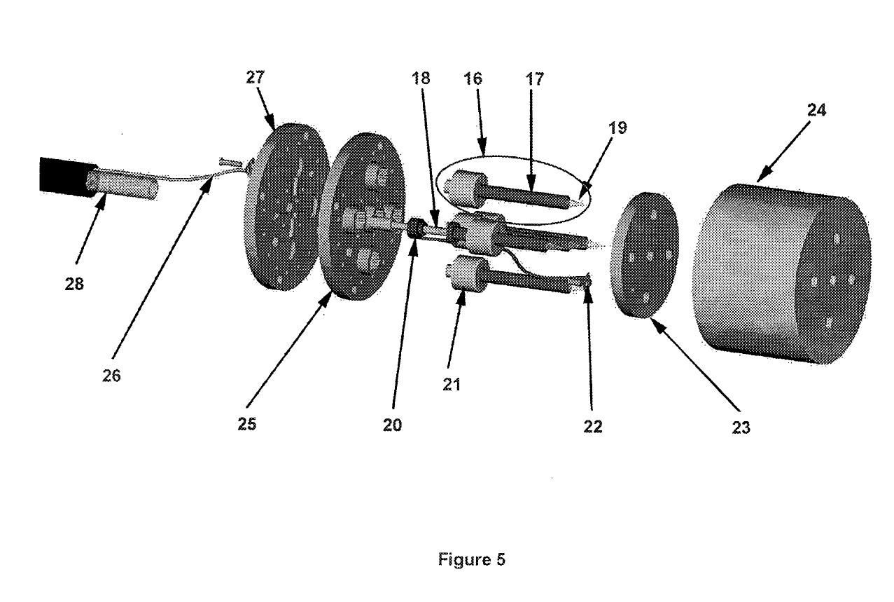

FIG. 5 depicts the component parts in an exemplary multi-probe embodiment, comprising more than one plasma torch generator. In general, the multi-probe embodiment can be multiple plasma torch generators as described here in FIG. 7. Alternatively, the electrical connections can be modified to accommodate multiple cathode/anode combinations, as in FIG. 5.

In FIG. 5, the plasma torch head unit (16) is presented in a five-probe environment. Each head unit contains an anode (17) and a cathode (18), for example a vortex cathode. The plasma torch (19) is shown exiting an orifice in the head unit. A cathode air flow distributor (20) and cathode insulating screw box (21) are located at the base of the head unit. The anode electrical terminal (22) is shown in position connected to the anode. The cathode electrical terminal (26) is shown at the cable, where anode electrical terminal (not shown) will also be present, in combination with gas or air supply tube (28). A plate (27) includes air flow apertures for distributing the pressurized air or gas to each plasma head unit. Plate (25) distributes electrical pulse to each plasma head or plasma head cathode. Plates (25) and (27) can function as airflow distributors and as electrical connections or conduits. Generally, insulators can be included to protect the component parts. Preferably, insulators are ceramic insulators or comprise ceramic materials. A plate (23) connects with terminal (22) to link multiple anodes, whereby voltage and/or current pulse can be distributed to each anode. Cover (24) positions plasma head units and provides thermal insulation and structural stability to the assembly as a whole. The use of plates to distribute an electrical pulse as shown here can more reliably generate equal or relatively equal potentials across each cathode/anode gap, which in turn would generate more consistent plasma torches. An optional

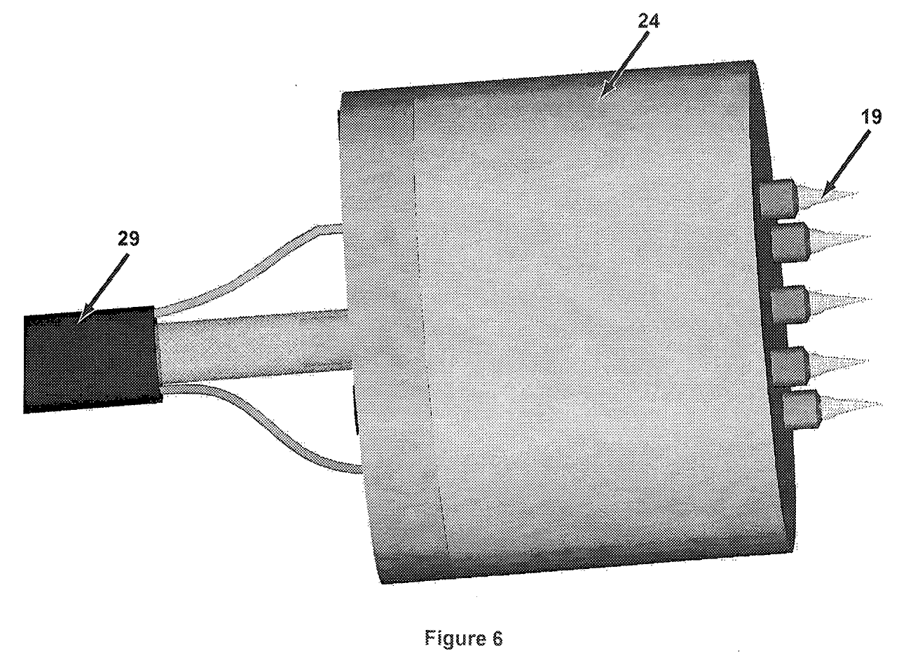

FIG. 6 depicts a multi-probe assembly as in FIG. 5. The plasma torches (19) are shown exiting the cover (24), however a cover can be optional. Cable (29) houses the electrical connection from the power source(s) to the anodes and cathodes as well as the air or gas supply tube. The assembly or device of FIG. 6 can be inserted into one end of a rocket body or designed as an integral part of a rocket body. The multi-probe examples of FIGS. 5 and 6 can be used in many rocket body designs or in any type of deployable housing.

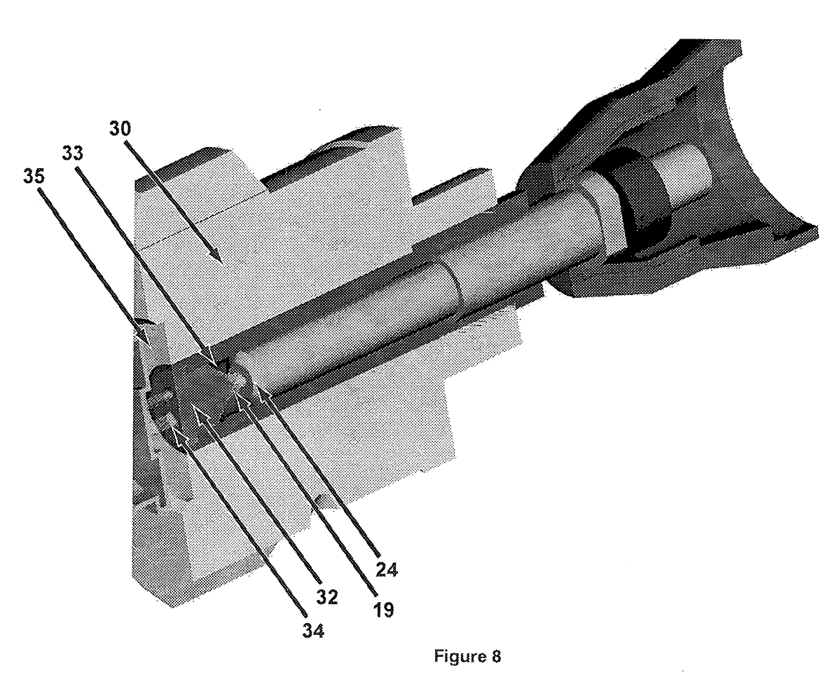

FIG. 8 depicts another embodiment of the invention, where a torch guide functions to separate the plasma torch and direct it in a particular direction. The embodiment of FIG. 8 shows a cutaway view of the cover of a plasma torch head (24). In this case, there is one plasma torch head, however, this same embodiment can be used with the multi-probe embodiment. A plasma torch (19) is shown extending into a gap (33) and through an optional torch guide (32). The torch guide is prepared from material capable of very high temperature contact and a preferred material is tungsten. In this case, the torch guide is cone-shaped. Any appropriate shape that can fit into the housing and allow the torch to extend through it can be selected. The torch guide contains one or more apertures (34) that direct the plasma torch in a specific direction, typically outside the housing. In FIG. 8, the torch guide (32) directs the plasma torch into four torches. This configuration may be used to protect the plasma torch from being extinguished by turbulent airflow. Housing (35) can be part of the deployable, powered rocket body as described.

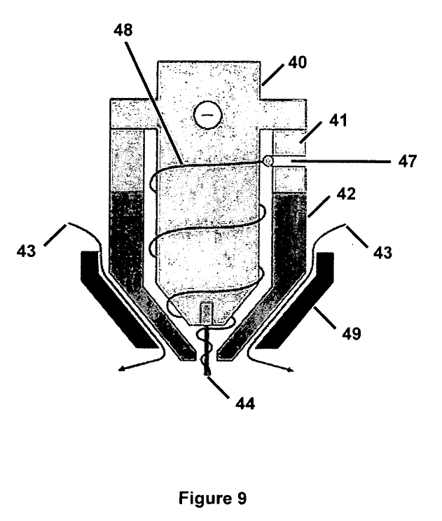

FIG. 9 depicts a schematic of an exemplary plasma head or generator embodiment with a particular airflow channel in a two electrode design. For example, cathode (40) and ring anode (42) reside inside a nozzle-like assembly and direct a high voltage spark in the direction of the primer or projectile (not shown). Air flowing through a gap between the anode and cathode beginning at inlet (47) and following schematic flow line (48) propagates the plasma torch at one end (44) when the voltage is applied. An optional insulator (41) can be included as in other embodiments. A shield (49) directs the propellant gas away from the internal plasma generating mechanisms to protect the device and in effect adds to the propellant force by directing the gas outward, as shown in air flowing at (43). This embodiment can be incorporated into the design of a flare to increase the size of the plasma flare emitted.

The following Examples, and foregoing description, are intended to show merely optional configurations for the devices of the invention. Variations, modifications, and additional attachments can be made by one of skill in the art. Thus, the scope of the invention is not limited to any specific Example or any specific embodiment described herein. Furthermore, the claims are not limited to any particular embodiment shown or described here.

In an exemplary method for igniting a plasma flare, a combination of hydrogen and oxygen gas is used. A modified Thermal Dynamics, (West Lebanon, N.H., USA) Drag-Gun Portable Plasma Cutting System with built-in air compressor can be used. A range of voltage and current settings can be evaluated for optimum conditions, such as speed of firing, length of plasma arc, temperature of plasma torch, and effect on UV and/or IR signature of plasma torch. Other parameters can also be evaluated. In addition, the gas or air flow over the plasma mechanism can also be varied for any preferred combination of voltage/current. A conventional initiation mechanism or control switch can be used to activate the plasma torch, as described for the Drag-Gun product or other available plasma torch device (see, for example, the thermodyne web page thermodyne.com). Of course, one of skill in the art is familiar with ways to modify the trigger or control switch device to provide, for example, multiple voltage and current pulses for each activation. A trigger or initiating mechanism in parallel with the conventional hand switch of the Drag Gun can also be used. Additional input can cease the control switch from generating successive plasma torches. In this and other embodiments of the invention, a conventional DC current can be used, although certain embodiments can use AC current.

For a 15 Amp setting, a range of voltages are used to generate a plasma torch using air pressure at 5 bar and a cathode/anode gap of approximately 0.625 mm. The device can be modified to expel a continuous air pressure of 5 bar and to vary the power output. Voltage settings between 10 V and 100 V/15 A can be tested. At 100 V, the heat is very intense, burning through a metal casing. Such a setting can be used in the plasma reactor with hydrogen and oxygen tanks to ensure that the plasma continues to be generated during the course of the countermeasure deployment. For a selected firing time of 10 ms, the combination of 85 V/15 A at 5 bar pressure produces an efficient heat source. Firing time, temperature, and an inspection of the primer condition after firing can be factors in 5 optimizing the apparatus for a desired setting or use. Also, as shown in the Figures, multiple plasma torches or a plasma torch divided into multiple torches through a torch guide Using the same or similar methods, a number of parameters can be modified, for example, a higher air pressure of 10 bar can be used with a 100 V/15 A combination. Also, the 85 V/15 A combination can be used with 3 bar pressure. The same can be said of the selection of the size of the cathode and anode. Here, we exemplify the preferred 20 kV high voltage pulse. However, a different voltage can be selected. For example, a voltage pulse from about 3 kV to about 20 kV can be selected to create the initial arc. Thus, from the information provided here, one of skill in the art can modify a number of the component parts, parameters, and conditions to arrive at an appropriate combination of cathode and anode combination, cathode/anode gap, number of cathodes and anodes, temperature, plasma characteristics, gas or air pressure, and voltage and/or current settings and pulses. And, one of ordinary skill in the art can appreciate that the parameters may be modified to achieve a desired UV and IR or radiation signature to mimic a target aircraft or vehicle, and additionally to use a combination of plasma torch flares to mimic a desired radiation signature.

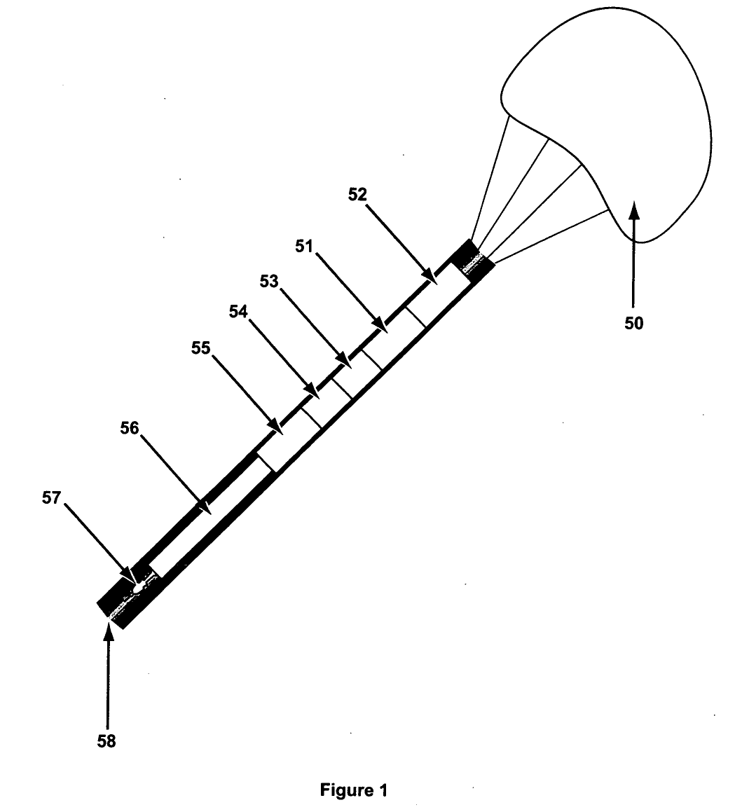

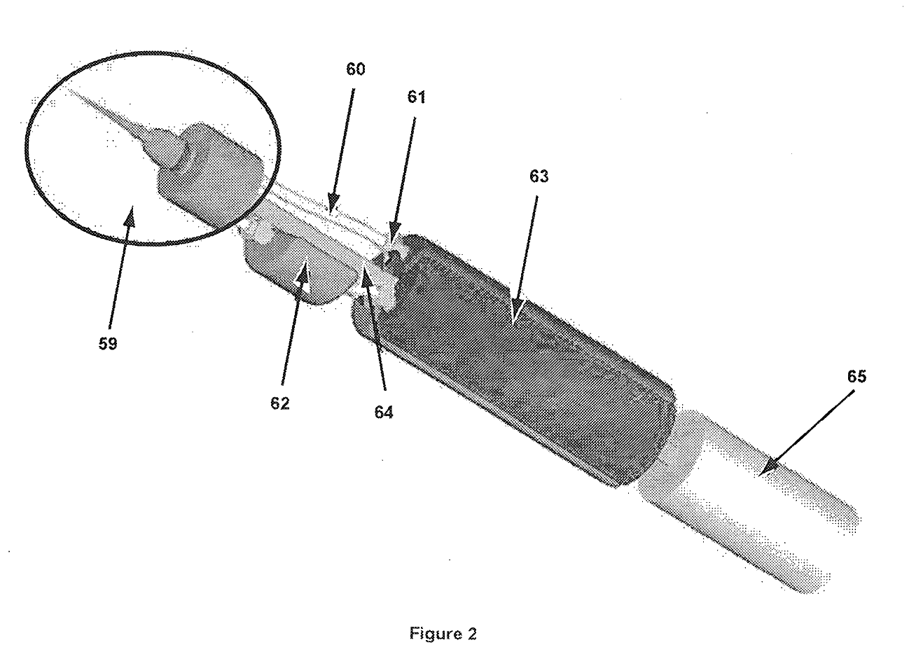

In the plasma flare countermeasure device of FIG. 1 or 2, a combination of hydrogen and nitrogen tanks is used. The tanks and the valves controlling the flow from the tanks are selected to produce from 3 to 5 bar of pressure, or up to 10 bar or pressure. The gas is mixed by a flow ring, as known in the art, to create an ionizable mixture. In one example, a mixture of 65% nitrogen and 35% hydrogen is used. As noted above, many other gases or mixtures of gases can be selected. Another option is 60% hydrogen, 40% nitrogen, or any combination or hydrogen, nitrogen, or oxygen in any ionizable mixture. The initial arc is generated between the anode and cathode, as above. The initial voltage can be 20 kV, as above. A high current pulse to generate plasma is initiated from the power source, with 100 V/15 A one example. The selection of voltage and current combinations can optimize the plasma generating reactor for a particular gas combination. For an expected 3-5 sec flare, the pulse can be either continuous over the 3-5 sec, or be a rapid on/off pulse. The size and capacity of the battery on the deployable housing may dictate the type of pulse to use for any particular design. To generate the plasma flare for a desired period of time, one of skill in the art is familiar with methods, tubing, and tanks to prevent the immediate explosion of the entire flare device and/or the gas tanks, of hydrogen or nitrogen for example, while maintaining an adequate supply of gas and/or power to sustain a plasma torch.

The tube or window protecting the plasma flare extending out the housing should optimally be composed of at least one UV and/or IR transmissive material. In other words, the tube or window should protect the plasma flare but allow the UV and/or IR light to escape. For example, Barium fluoride, germanium glass, Thalium Bromide, KRS-6, can be used in portions of the tube or window section. The window section can also be a long tube that allows plasma flare to exit but resists or prevents airflow from entering the tube to extinguish the plasma flare.

One skilled in the art can devise and create numerous other examples according to this invention. One skilled in the art is familiar with techniques and devices for incorporating the invention into a variety of rocket bodies, rocket systems, control systems, and plasma torch or thermal torch designs and examples existing or available, with or without additional elements know in the art. The invention is in no way limited by the scope of the examples, disclosure, or claims herein.

What is claimed is:

1. A countermeasure flare device comprising:
a plasma torch generator comprising an electrode, a gas nozzle for allowing gas to flow, a power source electrically coupled to at least the electrode;
a gas tank coupled to the gas nozzle;
an electric arc generator;
a housing, within which the plasma torch generator, gas tank, and control system resides, whereby the body can be deployed from a moving vehicle and the power supply is capable of generating a plasma torch for a desired time period and for more than about 3 seconds, without exploding the gas tank.

2. The device of claim 1, wherein the gas is selected from H₂ or N₂, or a combination of both.

3. The device of claim 1, further comprising a second gas tank and at least one regulator to mix the gas from the two tanks.

4. The device of claim 1, wherein the arc generator is coupled to the power source of the plasma torch generator, and the power source is capable of generating a charge of at least about 3 kV for use by the arc generator.

5. The device of claim 1, wherein the power source generates at least about 15 Amps DC current to initiate a plasma torch.

6. The device of claim 3, further comprising a third gas tank.

7. The device of claim 1, further comprising a second plasma torch generator.

8. The device of claim 1, further comprising a rocket engine coupled to the housing for propelling the housing.

9. The device of claim 1, further comprising a parachute.

10. The device of claim 1, wherein the electrode forms a cathode and a surface of the nozzle forms an anode between which an electric arc can form.

11. The device of claim 1, wherein the electrode forms a cathode, and further comprising an anode, where the gap between the cathode and anode is positioned so that gas from the gas nozzle flows across or adjacent to the gap.

12. The device of claim 1, further comprising a second gas tank and a gas mixing device to mix the gas from each of the gas tanks.

13. The device of claim 1, wherein the plasma torch generator is positioned at one end of the body, and further comprising a protective tube surrounding the end with the plasma torch generator, whereby the protective tube protects the plasma torch from being extinguished by turbulent air flow.

14. The device of claim 13, wherein the protective tube comprises a UV or IR transmissive material.

15. A method for generating a UV and IR emitting flare comprising: providing a countermeasure flare device as claimed in claim 1; applying a voltage to the electrode to generate an electric arc; causing gas to flow from the gas tank to the gas nozzle; and applying a current to the electrode to generate a plasma torch.

16. The method of claim 15, wherein the duration of the current is between about 5 sec to about 10 sec.

17. The method of claim 15, wherein the flare device contains two gas tanks and gas is provided during the same time period that the current is applied.

18. The method of claim 15, wherein the gas is hydrogen and nitrogen.

19. The method of claim 15, wherein the power source comprises a first generator for generating an arc using a voltage pulse and a second generator for applying the current.

20. The method of claim 15, wherein more than one plasma torch generator is provided in the countermeasure device.

21. The method of claim 15, wherein the voltage used is from about 3 to about 20 kV.

22. The method of claim 15, wherein the current used is about 15 amps.

23. A plasma reactor device for use with a countermeasure system, comprising:
a cathode;
an anode;
a gas nozzle for pressurized gas to flow between the cathode and the anode;
a gas supply for supplying gas to the gas nozzle;
a power source electrically coupled to the cathode and the anode for generating a plasma torch between the cathode and anode; and
a housing containing a UV or IR transmissive window, the housing positioned such that the plasma torch, when generated for a desired period of time, radiates light through the window.

24. The device of claim 23, wherein the gas supply comprises a gas tank for hydrogen and/or nitrogen.

25. The device of claim 23, wherein the cathode is a vortex cathode and the housing further comprises a parachute.

26. The device of claim 23, wherein the power source comprises two generators.

27. The device of claim 26, wherein a first generator is capable of providing a voltage to cause an arc to form between the anode and cathode.

28. The device of claim 26, wherein a second generator is capable of providing a current between the anode and the cathode to generate a plasma torch.

29. The device of claim 23, wherein the power source is capable of providing a current of about 5 to about 10 seconds in duration.

30. The device of claim 23, wherein the power source is capable of providing a current of about 5 to about 300 seconds in duration.

31. The device of claim 23, wherein the gas supply is capable of providing pressurized gas at about 3 to about 10 bar.

32. The device of claim 23, wherein the power supply comprises a first generator electrically coupled to the cathode and the anode for generating an arc across the anode and cathode, and a second generator electrically connected to the cathode and the anode for generating a plasma torch.

33. The device of claim 23, further comprising a valve operably connected to the gas supply.

34. The device of claim 23, further comprising a regulator to control the pressure inside the housing relative to outside the housing.

35. A method for redirecting a target-seeking missile comprising:
providing a plasma flare device comprising a cathode connected to a power source, a battery connected to the power source, an anode positioned with respect to the cathode to allow a pilot arc to form between cathode and anode when a voltage pulse is applied to the cathode, a gas tank connected to a gas supply nozzle directing gas toward or at the gap between the anode and the cathode, when the plasma flare device is housed in a deployable housing or rocket body;
launching or deploying the plasma flare device from a vehicle; and
generating a plasma torch for a desired period of time from the plasma flare device by initiating a pilot arc between the cathode and anode, a high current pulse from the power source, and a flow of gas through the gas supply nozzle.

36. The method of claim 35, wherein the plasma flare device further comprises a parachute.

37. The method of claim 35, wherein the plasma torch generated mimics the IR and UV signature of an aircraft engine and exhaust.

38. The method of claim 35, wherein the plasma torch is generated for about 5 to about 10 seconds.

39. The method of claim 35, wherein the plasma flare device comprises a hydrogen tank and a nitrogen tank, and further comprising a gas mixing chamber or regulator positioned between the gas supply tanks and the gas supply nozzle.
